(19) United States
(12) Patent Application Publication
(10) Pub. No.: US 2024/0159883 A1
(43) Pub. Date: May 16, 2024

(54) SENSOR DEVICE, SENSOR MODULE, IMAGING SYSTEM AND METHOD TO OPERATE A SENSOR DEVICE

(71) Applicant: ams-OSRAM Asia Pacific Pte. Ltd., Singapore (SG)

(72) Inventors: Peter TRATTLER, Seiersberg-Pirka (AT); Martin MAYER, Bärnbach (AT); Thomas JESSENIG, Attendorf (AT); Robert KAPPEL, Wettmannstätten (AT)

(73) Assignee: ams-OSRAM Asia Pacific Pte. Ltd., Singapore (SG)

(21) Appl. No.: 18/281,057

(22) PCT Filed: Feb. 28, 2022
(86) PCT No.: PCT/SG2022/050097

§ 371 Date: Sep. 8, 2023

(30) Foreign Application Priority Data
Mar. 12, 2021 (DE) 102021106090.7

(51) Int. Cl. G01S 7/497; G01S 7/4863; G01S 17/894

(52) U.S. Cl. CPC G01S 7/497; G01S 7/4863; G01S 17/894

(57) ABSTRACT

A sensor device comprises an array of photodetectors. A multiplexer circuit is connected to the array of photodetectors and provides dedicated output paths for each photodetector in the array, respectively. Furthermore, the sensor device comprises at least one control terminal. An array of time-to-digital converters is connected to output terminals of the multiplexer circuit. Depending on a control signal to be applied at the at least one control terminal, the multiplexer circuit is arranged to electrically connect only the output paths of a subarray of photodetectors to the output terminals of the multiplexer circuit.

### FIELD OF DISCLOSURE

This disclosure relates to a sensor device, a sensor module, an imaging system and to a method to operate a sensor device.

This patent application claims the priority of German patent application 102021106090.7, the disclosure content of which is hereby incorporated by reference.

### BACKGROUND

A single-photon avalanche diode, or SPAD for short, is a solid-state photodetector which finds increasing application in optical sensors including spectroscopy, medical technology, consumer, and security applications amongst others. SPAD arrays combine high sensitivity and spatial resolution, e.g. for highly accurate distance measurements in time-of-flight sensors. In a SPAD array often multiple zones are defined by a single pixel or a subarray of pixels. For example, a given zone in a SPAD array, which is embedded in a direct time-of-flight system, may be assigned to a region-of-interest in an image to create 3D spatial image data.

Optical sensors, e.g. those intended for use in mobile devices, are typically embedded in dedicated sensor modules which support or define the optical properties of the sensor. For example, sensor modules may provide a small, robust package, with built-in apertures and optics. During the assembly process of sensor modules, however, alignment of optics with respect to the sensor array may vary which leads to the problem of offset in the mapping of illuminated zones on the SPAD array and a field of view of the optics, for example. This misalignment may be due to assembly tolerances of a lens above the focal plane of the photodetector. To date misalignment can be reduced by using sophisticated and expensive optical alignment steps during manufacturing of the device. To do this an optical device may be monitoring the misalignment and moving the lens into the correct position before it is glued inside the package. Other solutions involve implementing a high resolution sensor and then cropping the image at the host. While these solutions are at hand, they come at high cost and often increased power requirements.

In other applications it may be beneficial to be able to customize a field-of-view, FOV, of a sensor device. For example, in time-of-flight sensors prior knowledge or expectation of a scene suggests that distance may only be relevant from certain directions. Typically, such customization is made possible by using high resolution sensors and crop the image to the desired FOV at the host. High resolution sensors, however, come at considerably higher cost. For example, in a time-of-flight sensor much higher power may be needed to achieve a given distance. Furthermore, cropping increases computational load as a higher number of pixels (i.e., typically higher than the FOV) need to be processed.

It is an objective to provide a sensor device, a sensor module and a method to operate a sensor device which allow the reduction of the impact of optical misalignment in a cost efficient manner.

This objective is achieved by the subject matter of the independent claim. Further developments and embodiments are described in dependent claims.

It is to be understood that any feature described in relation to any one embodiment may be used alone, or in combination with other features described herein, and may be used in combination with one or more features of any other of the embodiments, or any combination of any other of the embodiments unless described as an alternative. Furthermore, equivalents and modifications not described below may also be employed without departing from the scope of the gas sensor and the method of gas sensing which are defined in the accompanying claims.

### SUMMARY

The following relates to an improved concept in the field of optical sensors. It is suggested to use a multiplexer circuit which allows very fast and consistent multiplexing to achieve configurable mapping between photodetectors, such as SPADs, and time-to-digital converters, TDCs. Within the multiplexer circuit, the OR-function of the OR-ing of the outputs of the SPADs is implemented as well. It is suggested to implement the multiplexer circuit after the photodetectors but before the TDCs. This way photodetectors can be grouped into subarrays, or zones, on the sensor and, correspondingly, a FOV can be adjusted and customized at the hardware side and may not be left to cropping after time-to-digital conversion.

In at least one embodiment a sensor device comprises an array of photodetectors. A multiplexer circuit is connected to the array of photodetectors. The multiplexer circuit provides dedicated output paths for each photodetector in the array, respectively. The multiplexer circuit comprises at least one control terminal. An array of time-to-digital converters is connected to the output terminals of the multiplexer circuit.

During operation of the sensor device a control signal is applied to the at least one control terminal. Depending on the control signal, the multiplexer circuit electrically connects only the output paths of a subarray of photodetectors to the output terminals of the multiplexer circuit.

During operation all photodetectors may stay active. The multiplexer circuit electrically connects only the output paths of a subarray of photodetectors to the output terminals of the multiplexer circuit so that only sensor signals of these connected subarray of photodetectors is provided to the time-to-digital converters. While the photodetectors stay active only the sensor signals from the subarray is further processed. For example, the multiplexer circuit electrically connects only the output paths of a subarray of photodetectors to the output terminals of the multiplexer circuit so that only OR′d (or wired-OR) sensor signals of these connected subarray of photodetectors is provided to the time-to-digital converters.

The subarray may generally not be limited in terms of number of photodetectors. Similarly, the subarray may be formed by neighboring photodetectors to cover contiguous areas of the array of photodetectors. However, the photodetectors may be spread all over the array and still be part of the subarray. The allocation of a photodetector to the subarray is determined by the control signal. In effect, this allows to customize the subarrays (or zones) to a desired form, including dynamic configuration or mapping between photodetectors and time-to-digital converters. In practice, the number of time-to-digital converters may be kept low, i.e. lower than the number of photodetectors in the array. This may put some limitation on the number of photodetectors which can be allocated to the subarray at the same time.

In more detail, the multiplexer circuit allows to electronically correct for optical center misalignments, which often occur in a final package of the sensor device and which are caused by assembly tolerances, for example. Due to such assembly tolerances of an imaging system, there often is a misalignment of the optics or lenses above a focal plane of the photodetector or sensor array. To date this may be reduced by using sophisticated and expensive optical alignment steps during manufacturing of the device. To do this, an optical device monitors the misalignment and moves the lens into the correct position before it is glued inside the package. The proposed sensor device may avoid this alignment step and allows for electronic adjustment of the optical center in a final test. This avoids costly optical alignment steps during assembly and reduces the overall cost of the solution. This concept is sometimes called ‘optical misalignment correction.

Additionally, the proposed concept allows for a highly customizable mapping of the photodetectors, such as SPADs, or single photon avalanche diodes, to the time-to-digital converters, TDC. This allows any shape of zones while using a limited number of rather expensive TDCs. This may support further applications, such as mobile phone or LDAF, laser distance autofocus, and AR, augmented reality. For example, shaping the FOV zone to fit the regions and aspect ratio of the phone and aligning of the zone's optical center and size to the camera. For example, in a zoomed image, an application needs to have smaller zones, for wide angle, and use larger zones for telephoto range. In presence detection it is possible to match the expected FOV and correct the detection range. In smart speaker applications there may be a need for a wide FOV but with narrow height, which mimics the locations where the speaker assumes people are present. The proposed concept allows to fit the zone shape to this. Another possible application is in robotic vacuum cleaners to avoid collision. Here the zones (subarray) and optical sensor may detect a wall, but not the floor.

The multiplexer circuit can be implemented in a symmetrical fashion and allows a very fast and consistent multiplexing operation to achieve configurable mapping between the photodetectors and the TDCs. The concept, however, cannot be implemented with regular multiplexing circuitry as this would introduce way too many and inconsistent delays, e.g. making a time-of-flight sensor, such as dToF sensor, unusable. The multiplexing delay shall be kept very low in order to achieve reasonable time accuracy.

In at least one embodiment the photodetectors of the array are arranged in rows and/or columns. The multiplexer circuit comprises first branches and a second branch. Each first branch provides the output paths for photodetectors of a common row or a common column. The second branch comprises the output terminals. Finally, a logic connects the output paths to the output terminals of the multiplexer depending on the control signal. A delay of only 200 ps would otherwise generate a distance measurement error of 3 cm.

For example, a given row of photodetectors is associated with a dedicated first branch. This dedicated first branch provides the output paths of said row of photodetectors. Another row of photodetectors is associated with another dedicated first branch which provides the output paths of this row of photodetectors. Overall, each row may be associated with a corresponding dedicated first branch. The output paths may be implemented as multiplexer lines which connect the photodetectors to the second branch, respectively. The term “row” may be interchanged with “column”. While each photodetector may be connected to one of the first branches, those connections may not at all times be electrically conducting. Depending on the control signal, only a subset of photodetectors are electrically connected to their corresponding first branch, so that their output paths are electrically connected to the second branch. For example, if more than one photodetector (e.g. SPAD) signal is connected to a branch, the signals are automatically OR′d together.

The electrical connections may be established by the logic, which receives the control signal. The logic connects the output paths of individual photodetectors using their corresponding first branches to the output terminals. This way, the photodetectors which, by way of the control signal, are allocated to the subarray of photodetectors are electrically connected, via the output terminals, to corresponding time-to-digital converters.

The multiplexer circuit provides control as to which of the photodetectors are allocated to output their sensor signals to the time-to-digital converters, thus, defining the subarray. This is done via the first branches dedicated to the rows or columns, which direct the output paths of the photodetectors of the subarray to the output terminals of the second branch. In a certain sense, the second branch collects the allocated output paths from the first branches and redirects them to the output terminals, and, thus, to the time-to-digital converters. The logic receives the control signal and controls the first branches and the second branch, i.e. allocates the photodetectors to the subarray to conduct time-to-digital conversion by means of the time-to-digital converters.

In at least one embodiment the first branches are wired-OR connected to the second branch via the logic. A logical OR allows for combining two signals so that the output is on if either signal is present. This can be accomplished by an OR logic gate, e.g. two inputs, one output which is high if either input is. It can also be done with a “wired-OR” connection. For example, in a wired-OR connection two signals are wired together and either one of them can raise a level. For example, for SPADs the signals are driven by a quencher that pulls up or pulls down an output received at the control terminal.

In at least one embodiment the photodetectors in the array are wired-OR connected to the output paths of the first branches. Similar to the first branches wired-OR to the second branch, the photodetectors in the array can be wired-OR connected to the first branches. This way the multiplexer circuit has a high degree of symmetry and can be considerably faster than regular multiplexer architectures. This allows to reduce delays and increase time accuracy for time-to-digital conversion. It additionally allows to keep the individual delays of the branches very similar.

In at least one embodiment the multiplexer circuit comprises at least one reference channel which feedbacks the output terminals to the array of photodetectors. Thus, the multiplexer can be extended by additional channels such as reference channel, while keeping the symmetrical layout of the circuit. This may be beneficial for applications where time resolution is at the essence, e.g. time-of-flight detection in view of a reference, or start, signal.

In at least one embodiment, the time-to-digital converters of the array of time-to-digital converters are connected to at least two output terminals. Typically, time-to-digital converters constitute cost intensive components. Thus, sharing of time-to-digital converters among one or more channels may reduce overall cost. The multiplexer circuit can be designed to assign one time-to-digital converter to several output terminals without loss of accuracy. By means of the control signal channels are allocated to time-to-digital converters, as discussed above.

In at least one embodiment a number of photodetectors from the array are allocated to form the subarray depending on the at least one control signal. Furthermore, the at least one control signal defines one or more operating configurations. In fact, allocation by means of the control signal provides a high degree of freedom. The resulting subarray may neither be restricted in shape or number of allocated photodetectors, i.e. within the limits provided by the sensor.

In at least one embodiment the subarray is determined by a first number of photodetectors, in a ground configuration, which are located around a common center of the array of photodetectors. For example, in the ground configuration the subarray is centered at the array as the sensor device may be operated under the assumption that it is aligned with respect to an optical system.

In a first operating configuration, the subarray comprises photodetectors which are offset relative to the common center of the array of photodetectors. For example, the offset may be determined or set when the above assumption is found invalid. Thus, the offset may account for optical misalignment.

In addition, or alternatively, in a second operating configuration, the subarray comprises a second number of photodetectors which is different from the first number of photodetectors. For example, accounting for optical misalignment may be done with a same number of photodetectors allocated to the subarray. Furthermore, the subarray may have the same shape. In a certain sense, the subarray is shifted along rows and/or columns according to the offset rather than being alerted in shape and number of photodetectors. However, implementing an offset or not, the subarray may be formed by a different, i.e. second, number of photodetectors. This allows to alter not only offset but shape and size of the subarray. In fact, shape and size may only be limited by the number of time-to-digital converters which are present in the device. This allows to allocate the subarray to best fit an intended application.

In at least one embodiment the subarray is determined by photodetectors of the array from a contiguous array area of the array. This allows to map a desired field of view of the sensor device.

In at least one embodiment a sensor module comprises at least one sensor device according to one or more of the aspects discussed above. A sensor package encapsulates the at least one sensor device. Optics are arranged in the sensor package. The first subarray of photodetectors is located in a field of view of the optics.

The proposed sensor device can be used in various sensor modules such as optical sensors, rangefinders, and proximity sensors to name but a few. Basically, the proposed sensor device can be embedded into sensor modules which facilitate an array of photodetectors which may need to be aligned with respect to optics, such as a lenses or lens systems.

For example, in order to account for misalignment during manufacture of the sensor module the sensor device provides the means to compensate for offset. In particular, the sensor device which is embedded in the sensor module can be operated in a ground configuration or be calibrated and operated in a calibrated configuration. The one or more control signals may be provided by an external terminal connected to the at least one control terminal or by means of internal components such as a microprocessor or state machine, or the like.

In at least one embodiment the at least one sensor device, the sensor package and the optics are arranged as a time-of-flight sensor module. For example, the sensor package comprises one or more chambers into which one or more sensor devices are positioned. The optics are arranged in apertures of the chambers and, correspondingly, the sensor device is arranged below the apertures inside the sensor package.

Time-of-flight applications benefit from fast response times and low propagation delay from the photodetectors to the time-to-digital converters. This allows for higher accuracy of time-of-flight and, thus, improved range detection or 3D imaging.

In at least one embodiment an imaging system comprises at least one sensor device according to one or more of the aspects discussed above. The at least one sensor device is embedded in a host system. For example, the host system comprises a mobile device, a 3D-camera, a spectrometer, a speaker (or smart speaker such as Echo devices), a robotic device (such as a robotic vacuum cleaner or mower), etc.

For example, the mobile device can be a mobile phone, Smartphone, computer, tablet or the like. The sensor device can be implemented into the mobile device using a sensor module as discussed above. This way the sensor device can be used as an optical sensor, e.g. in rangefinders, proximity sensors, color sensors or time-of-flight sensors. In some embodiments the sensor device or sensor module comprises internal electronics for its operation such as a microprocessor or state machine, or the like. In other embodiments, however, the imaging system provides electronics to operate the sensor device.

Possible applications include cameras of a mobile phone, LDAF (laser distance autofocus) and AR (augmented reality). In general, shaping of the subarray (or zone) allows to fit the regions and aspect ratio, e.g. of the phone's camera, and aligning of the zone's optical center and size, e.g. to the camera. Another application relates to correction of misalignment of time-of-flight to camera in or after production. In an imaging device shaping the subarray may implement a zoomed image, e.g. with smaller zones, for wide angle, and larger zones for telephoto range. In presence detection an expected FOV can be matched and corrected for the corresponding detection range. For example, smart speakers may have presence detection implemented in the device. Such an application may need a wide FOV but only a narrow height. Shaping of the subarray may allow to fit to this. In robotic devices such as vacuum cleaners of mowers collision avoidance may benefit from the proposed concept, e.g. shaping of the zone of an optical sensor may be focused to detect a wall, but not the floor.

Further examples may relate to a 3D-camera which comprises a time-of-flight, TOF, camera and is arranged for 3D imaging. Typically, such as system comprises an illumination unit such as a photodiode or laser diode. One example illumination unit comprises a Vertical Cavity Surface Emitting Laser, VCSEL, to illuminate an external object. Optics such as a single lens or objective lens are used to gather light being reflected from the external object and to image onto the sensor device, e.g. CMOS or CCD photo sensor. The sensor device can be used to determine a time-of-flight to the external object, e.g. the photodetectors can be read out and provide sensor signal which are a direct measure of the time the light has taken to travel from the illumination unit to the object and back to the array.

The host system or sensor module comprising the sensor device may be complemented with driver electronics to control the illumination unit and the sensor device. Furthermore, the sensor module or sensor device may have an interface in order to communicate with the host system.

In a 3D-camera imaging system two types of images may be generated: a regular 2D image and an additional 1D image with distance information. These two images can be combined to yield a 3D image. The sensor device allows for compensating an optical offset on a device-basis. Thus, 2D image and an additional 1D image can be aligned with higher accuracy.

In a spectrometer incident light of a defined wavelength may be imaged on a defined position of the sensor device, e.g. a defined photodetector or array of photodetectors such as the subarray. In order to improve spectral resolution it can be important to account of optical offsets. The sensor device allows doing so on a device-basis.

In an embodiment of a method to operate a sensor device, the sensor device comprises an array of photodetectors, a multiplexer circuit and an array of time-to-digital converters which are connected to output terminals of the multiplexer circuit. The method comprises the steps of providing dedicated output paths for each photodetector in the array, respectively, using the multiplexer circuit connected to the array of photodetectors. A control signal is applied to the multiplexer circuit via at least one control terminal. Depending on a control signal, the multiplexer circuit electrically connects through the output paths of photodetectors only the output path of a subarray of photodetectors to the output terminals of the multiplexer circuit.

In at least one embodiment the method further comprises allocating a number of photodetectors from the array to form the subarray, depending on the at least one control signal. One or more operating configurations are defined by the at least one control signal.

In at least one embodiment in a ground configuration, the subarray is determined by a first number of photodetectors which are located around a common center of the array of photodetectors. In a first operating configuration, the subarray comprises photodetectors which are offset relative to the common center of the array of photodetectors. In a second operating configuration, the subarray comprises a second number of photodetectors which is different from the first number of photodetectors. The method comprises the further steps of determining the offset to compensate for optical misalignment or setting the second number of photodetectors by means of the control signal depending on a desired region of interest. This allows to create a fully customized field of view of the sensor. The shape of the zones ca be customized in size, form and position.

This supports easier optical center correction with much better granularity for the correction as one can correct with a step size of 1 photodetector and each zone (or pixel) may typically have 8 to 64 photodetectors used. If the correction would be done after the image is captured, as prior art is often doing, the step size is only one zone. This may be especially relevant for dToF sensors with moderate resolution, for example when using 16 zones. A correction by ±1 zone would not be usable in a final application and may be much too coarse. Additionally, the proposed concept provides the freedom to change the zone size, shape and number of zones with different configurations. This allows customization of the zone to the applications.

Further embodiments of the method to operate a sensor device according to the improved concept become apparent to a person skilled in the art from the embodiments of the sensor device, sensor module and imaging system described above, and vice versa.

The following description of figures of example embodiments may further illustrate and explain aspects of the improved concept. Components and parts with the same structure and the same effect, respectively, appear with equivalent reference symbols. Insofar as components and parts correspond to one another in terms of their function in different figures, the description thereof is not necessarily repeated for each of the following figures.

### BRIEF DESCRIPTION OF THE DRAWINGS

In the Figures:

FIG. 1 shows an example embodiment of a sensor device,

FIG. 2 shows an example embodiment of the horizontal mux,

FIG. 3 shows an example embodiment of the vertical mux,

FIG. 4 shows an example application of the proposed sensor device, and

FIG. 5 shows an example application of the proposed sensor device.

### DETAILED DESCRIPTION

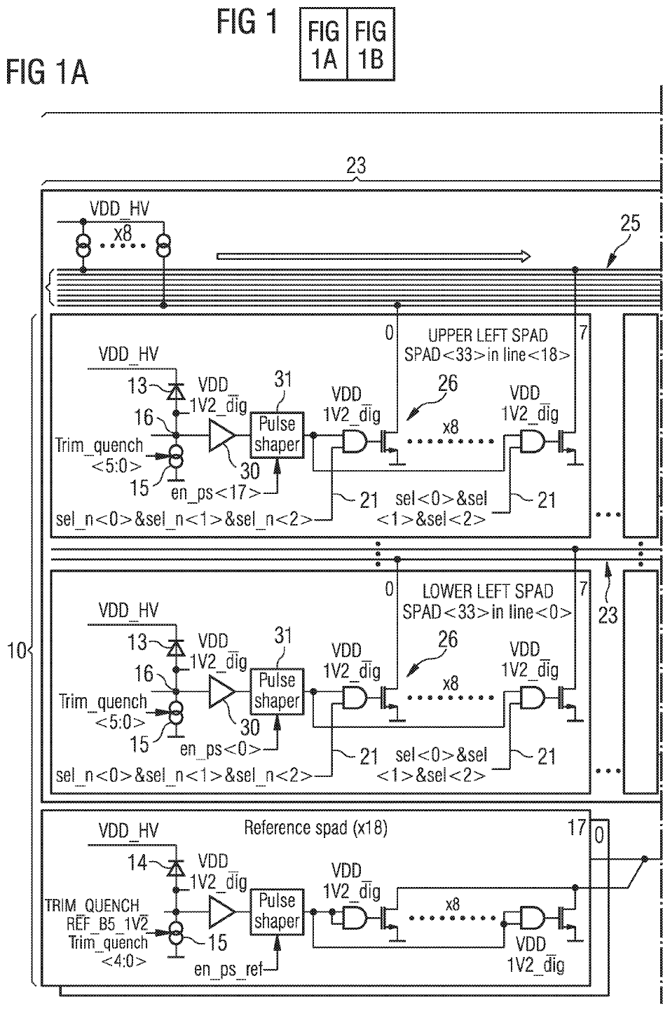

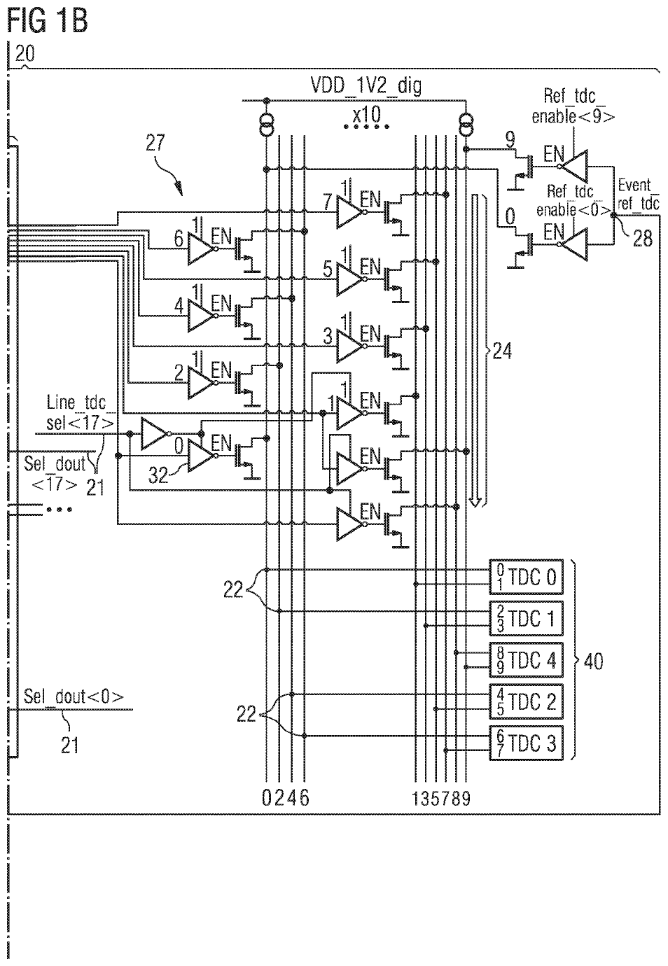

FIG. 1 shows an example embodiment of a sensor device. The sensor device comprises an array 10 of photodetectors, a multiplexer circuit 20 and an array of time-to-digital converters 40.

The array comprises photodetectors which are arranged in rows and columns. For example, the photodetectors are single-photon avalanche photodiodes, SPADs. However, the concept presented in more detail below can be applied to other types of photodetectors. In the drawings a single SPAD 13 from the array is represented by a photodiode symbol for easy reference. The array in this embodiment comprises 8×8 SPADs, i.e. every row and every column have 8 SPADs. This array has been chosen as an example and for easier explanation. The number of SPADs in a row or column is not restricted to any limited number, and may be different for rows and columns. The SPADs are connected to ground via quenchers 15 and to a supply voltage VDD_HV. A circuit node 16 connecting a quencher 15 and a SPAD 13 is connected to the multiplexer circuit 20 via a pulse shaping circuit comprising an amplifier 30 and a pulse shaper 31.

The multiplexer circuit comprises first branches 23 and a second branch 24. In this embodiment there is one first branch 23 for each row of the array of photodetectors (indicated by “ . . . ” in the drawing). The first branches 23 comprise multiplexer lines 25 which provide output paths for the SPADs. A logic 25 of the multiplexer comprises first sections 26 and second sections 27. Each first branch comprises a first section 26 of the logic which is connected to an output of the pulse shaper. The first section wires-or each SPAD 13 of a row to all multiplexer lines 25 and comprises control terminals 21 to receive control signals. The wired-OR connection receives one input from a SPAD and another from the control terminals. By means of the wired-OR the inputs are connected together so that the first section acts like multiple OR gates.

The first branches for the remaining rows have the same circuit architecture so that each row has dedicated multiplexer lines 25 as possible output paths, respectively. There is a dedicated logic which wires-or each SPAD of a given row to all multiplexer lines 25 of the corresponding first branch of the multiplexer circuit. For easier representation the drawing includes a space holder “ . . . ” everywhere elements are repeated.

The second branch 24 of the multiplexer circuit is connected to the first branches 23 via second sections 27 of the logic. In this embodiment there is a section 27 for each first branch, i.e. for each row of the array of photodetectors, connected to multiplexer lines 25. The second branch 24 comprises multiplexer lines 0, . . . 9, denoted channels, which electrically connect to output terminals 22. The second sections wire-or connect all multiplexer lines from the first branches 23 to the multiplexer lines 0, . . . 9 of the second branch 24. The second sections 27 of the logic comprise control terminals 21 to receive control signals, e.g. an enable signal. The wired-OR connection receives one input from a multiplexer line 25 of a first branch and another from control terminals 21, for example. By means of the wired-OR the inputs are connected together so that the second sections acts like multiple OR gates.

In this example embodiment the second branch 24 comprises 8 multiplexer lines, or channels 1, . . . , 8, which are used to connect to the output paths, or multiplexer lines 25, of the rows of photodetectors connected to the first branches 23, respectively. Furthermore, two multiplexer lines 0, and 9 are reserved for reference photodetectors 14. The multiplexer lines of the second branch 24 are denoted channels. In this embodiment there are 10 channels, including the two reference channels which feedback output terminals 22 of the reference SPADs 14 of the array 10 of photodetectors.

The first and second branches form the multiplexer circuit and are denoted horizontal mux and vertical mux hereinafter.

The array of time-to-digital converters, or TDC, 40 is connected to the output terminals of the vertical mux. In this embodiment, the vertical mux is wired-OR so that 8 SPADs from each row of SPADs can be muxed to 10 TDC channels (including the two reference SPADs). The TDCs comprise two inputs which are connected to two output terminals of the multiplexer circuit, respectively.

The multiplexer circuit is largely symmetric due to the implementation of horizontal and vertical mux using the same or similar wired-OR logical architecture. This way temporal delays can be minimized and the multiplexer is considerably faster than common circuits. This allows also to keep each delay almost equal.

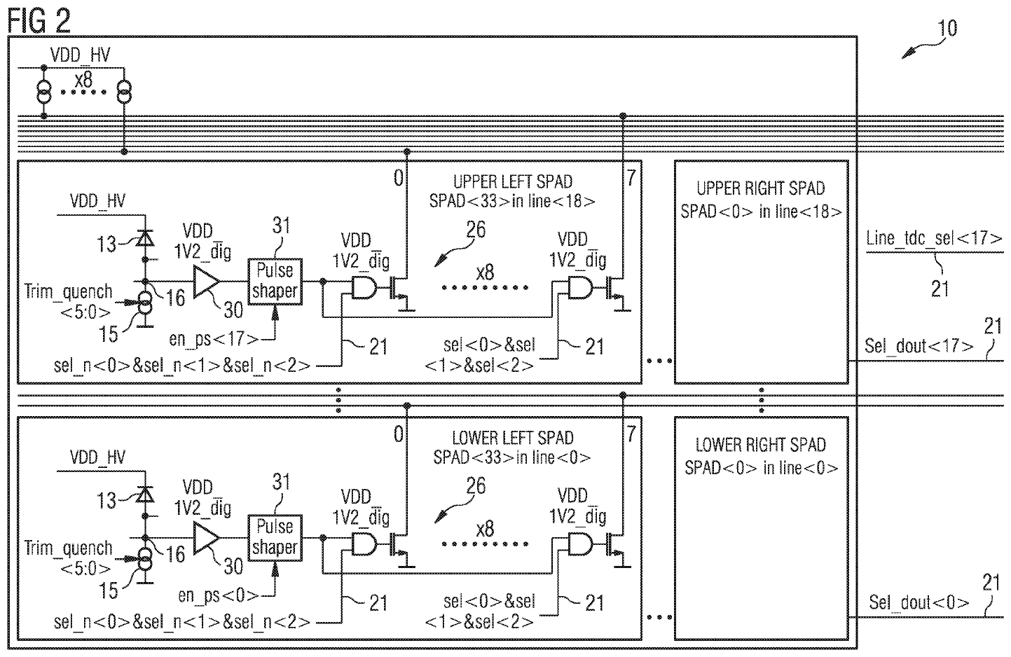

FIG. 2 shows an example embodiment of the horizontal mux. The drawing shows the horizontal mux circuit from FIG. 1 in greater detail. The first section 26 of the logic comprises a parallel connection of logical OR gates. There are as many gates as there are multiplexer lines 25. The gates comprise a wired-AND gate and a MOSFET transistor, wherein an output of the wired-AND gate is connected to a control terminal of the transistor (i.e. gate), respectively. One input of the gate is connected to a SPAD via the pulse shaper 31 to receive a pulse of the SPAD 13. Another input is connected to a control terminal 21. The source or drain terminals of the transistor are connected to one multiplexer line 25. Each gate is connected to a unique multiplexer line, and, in turn, the multiplexer lines 25 can be addressed in a unique fashion, e.g. via applying a corresponding control signal at the dedicated control terminal 21. Use of transistor, MOSFET or otherwise, reduces parasitic capacitances. The control signal may be provided by another component, such as a controller or state machine, for example.

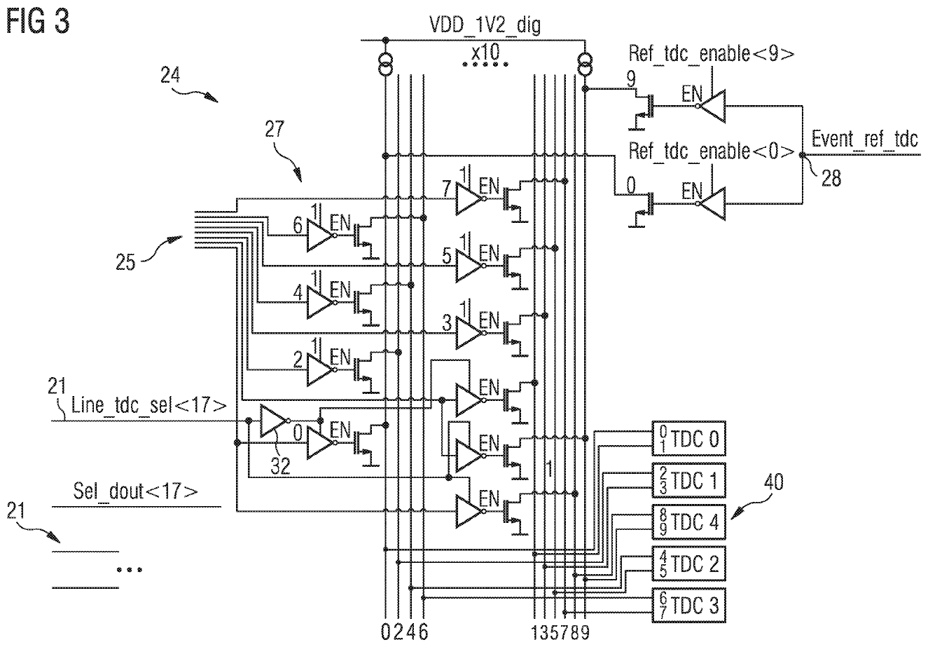

FIG. 3 shows an example embodiment of the vertical mux. The drawing shows the vertical mux circuit from FIG. 1 in greater detail. The second section 27 of the logic comprises a parallel connection of logical OR gates. There are as many gates as there are multiplexer lines 25. The gates comprise a wired-AND gate and a MOSFET transistor, connected as depicted in the drawing.

A control side of each wired-AND gate is connected to one control terminal 21 via a respective inverter 32. One inverter 32 is shared by (and electrically connected to) another control side of another gate, for example. An output of a NOT gate is connected to a control terminal of the transistor (i.e. gate), respectively. One input of the gate is connected to a multiplexer line 25 to receive a pulse of the SPAD 13. Another input is connected to a control terminal 21 and guides an output of one gate to another gate. Source or drain terminal of the transistors are connected to one multiplexer line, or channel 0, . . . 9, of the vertical mux. Each gate is connected to a unique channel, and, in turn, the channels can be addressed in a unique fashion, e.g. via applying a corresponding control signal at the dedicated control terminal. Use of transistors, MOSFET or otherwise, reduces parasitic capacitances. The control signal may be provided by another component, such as a controller or state machine, for example.

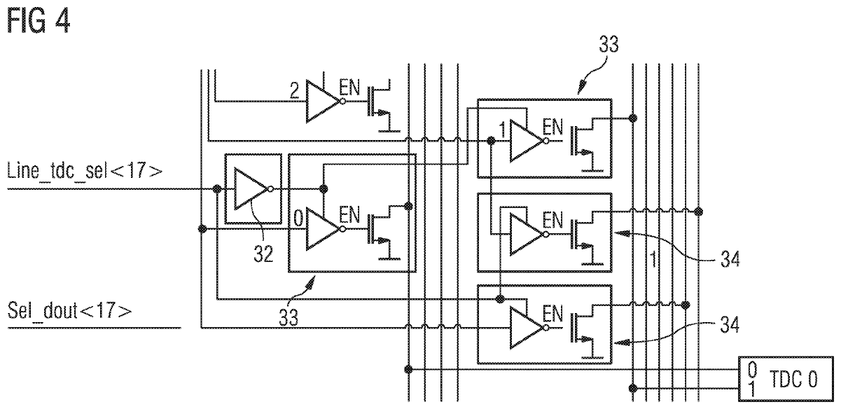

FIG. 4 shows a cutout from the example embodiment of the vertical mux. The drawings shows an example inverter 32, a first pair 33 of wired-OR gates, i.e. wired-AND gate and a MOSFET transistor and a second pair 34 of wired-OR gates. Due to the inverter 32 either wired-ORs of the first pair or the wired-ORs of the second pair framed are active, e.g. connected to TDC0 or TDC4. This implementation is optional and helps to save configuration hits.

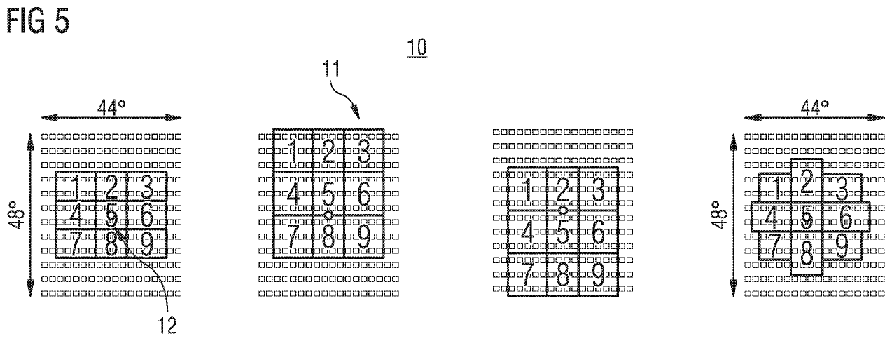

FIG. 5 shows an example application of the proposed sensor device. The drawing shows an array of photodetectors and an example subarray of 3×3. The background indicates an available focus plane for adjustment. By means of the multiplexer circuit center of the subarray can be moved up, down, left, right, and re-sized as needed, e.g. to compensate for misalignment. Furthermore, shape of the subarray and number of photodetectors allocated to the subarray can be almost arbitrarily.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims.

### REFERENCE NUMERALS

0, 9 reference channels
1, . . . , 8 channels
10 array of photodetectors
11 subarray
12 common center
13 SPAD
14 reference SPAD
15 quencher
20 multiplexer circuit
21 control terminal
22 output terminal
23 first branch
24 second branch
25 multiplexer lines
26 first section
27 second section
28 output terminal
30 amplifier
31 pulse shaper
32 inverter
33 first pair of wired-ORs
34 second pair of wired-ORs
35 array of time-to-digital converters
50 time-of-flight sensor module
51 sensor package
52 optical lens
53 molded chamber
54 integrated circuit
55 light barrier
56 sensor device

1. A sensor device, comprising:
an array of photodetectors,
a multiplexer circuit connected to the array of photodetectors and providing dedicated output paths for each photodetector in the array, respectively, further comprising at least one control terminal,
an array of time-to-digital converters connected to output terminals of the multiplexer circuit;
wherein, depending on a control signal to be applied at the at least one control terminal, the multiplexer circuit is arranged to electrically connect only the output paths of a subarray of photodetectors to the output terminals of the multiplexer circuit,
wherein the photodetectors of the array of photodetectors are arranged in rows and/or columns, and
wherein the multiplexer circuit comprises:
first branches, wherein each first branch provides the output paths for photodetectors of a common row or common column, and
a second branch, wherein the second branch comprises the output terminals, and
a logic which, depending on the control signal, connects the output paths to the output terminals of the multiplexer circuit.

2. (canceled)

3. The sensor device according to claim 1, wherein the first branches are connected to the second branch wired-OR via the logic.

4. The sensor device according to claim 1, wherein the photodetector in the array are wired-OR to output paths of the first branches.

5. The sensor device according to claim 1, wherein the multiplexer circuit comprises at least one reference channel which feedbacks the output terminals to the array of photodetectors.

6. The sensor device according to claim 1, wherein time-to-digital converters of the array of time-to-digital converters are connected to at least two output terminals.

7. The sensor device according to claim 1, wherein:
a number of photodetectors from the array are allocated to form the subarray depending on the at least one control signal, and
the at least control signal defines one or more operating configurations.

8. The sensor device according to claim 7, wherein
in a ground configuration, the subarray is determined by a first number of photodetectors which are located around a common center of the array of photodetectors,
in a first operating configuration, the subarray comprises photodetectors which are offset relative to the common center of the array of photodetectors, and/or
in a second operating configuration, the subarray comprises a second number of photodetectors which is different from the first number of photodetectors.

9. The sensor device according to claim 1, wherein the subarray is determined by photodetectors of the array from a contiguous area of the array.

10. A sensor module comprising:
at least one sensor device according to claim 1,
a sensor package encapsulating the at least one sensor device and
optics arranged in the sensor package, wherein the first subarray of photodetectors is located in a field-of-view of the optics.

11. The sensor module according to claim 10, wherein the at least one sensor device, the sensor package and the optics are arranged as a time-of-flight sensor module.

12. An imaging system, comprising:
at least one sensor device according to claim 1, and
a host system where the at least one sensor device is embedded in.

13. A method to operate a sensor device, the sensor device comprising an array of photodetectors arranged in rows and/or columns, a multiplexer circuit and an array of time-to-digital converters connected to output terminals of the multiplexer circuit;
wherein the multiplexer circuit comprises:
first branches, wherein each first branch provides the output paths for photodetectors of a common row or common column, and
a second branch, wherein the second branch comprises the output terminals, and
a logic,
the method comprising:
providing dedicated output paths for each photodetector in the array, respectively, using the multiplexer circuit connected to the array of photodetectors,
applying a control signal to the multiplexer circuit via at least one control terminal,
depending on the control signal, electrically connecting through the output paths of photodetectors only the output paths of a subarray of photodetectors to the output terminals of the multiplexer circuit, and
depending on the control signal, connecting the output paths to the output terminals of the multiplexer circuit through the logic.

14. The method according to claim 13, further comprising:
allocating a number of photodetectors from the array to form the subarray depending on the at least one control signal, and
defining one or more operating configurations the at least control signal.

15. The method according to claim 14, wherein:
in a ground configuration, the subarray is determined by a first number photodetectors which are located around a common center of the array of photodetectors,
in a first operating configuration, the subarray comprises photodetectors which are offset relative to the common center of the array of photodetectors,
in a second operating configuration, the subarray comprises a second number of photodetectors which is different from the first number of photodetectors, and wherein the method comprises:
determining the offset to compensate for optical misalignment, or
setting the second number of photodetectors by means of the control signal depending on a desired region-of-interest.
